(19) United States
(12) Patent Application Publication
(10) Pub. No.: US 2004/0179813 A1
(43) Pub. Date: Sep. 16, 2004

(54) Disk reproduction apparatus allowing setting of book mark for reproducing disk, and disk reproduction method

(76) Inventor: Koji Kobayashi, Osaka (JP)

Correspondence Address: OSHA & MAY L.L.P., 1221 MCKINNEY STREET, HOUSTON, TX, 77010, US

(21) Appl. No.: 10/798,087

(22) Filed: Mar. 11, 2004

(30) Foreign Application Priority Data
Mar. 14, 2003 (JP) 2003-070167(P)

(51) Int. Cl. H04N 5/91

(52) U.S. Cl. 386/46

(57) ABSTRACT

By operating a marker key during reproduction from a disk on a DVD player, the address on the disk currently played is registered as a book mark. Upon operating the marker key when a disk is not being played, a still picture of the address registered as a book mark is displayed as a thumbnail image in a thumbnail display region in a marker display region. The DVD player initiates reproduction from a disk starting from the address corresponding to the selected marker No. in response to selection of a marker No. corresponding to a relevant thumbnail image in the marker No. display region by the user.

### BACKGROUND OF THE INVENTION

1. Field of the Invention

The present invention relates to a disk reproduction apparatus and disk reproduction method. More particularly, the present invention relates to a disk reproduction apparatus and disk reproduction method that can administer information to facilitate the process of reproducing data from a disk in a manner the user desires in a disk reproduction apparatus.

2. Description of the Background Art

Conventionally, there is known the technique to reproduce information recorded on a disk in a disk reproduction apparatus. In recent years, significant development has been seen in the increase of the capacitance of disks such as a DVD (Digital Versatile Disk). In accordance with such increase in the capacitance of disks, the technique of generating and displaying a preview screen at a predetermined interval is disclosed in, for example, Japanese Patent Laying-Open No. 2001-326910.

When the user wants to initiate reproduction partway from the disk in accordance with the technique disclosed in the aforementioned publication, the user had to search for a preview screen located close to the desired position of reproduction from the preview screens produced at a predetermined time interval. There was inconvenience on part of the user when reproducing data from a disk in a desired manner.

The technique disclosed in the above publication poses no problem if the positions of reproduction where the user wishes to play is located across the entire disk, i.e. the positions where the user wishes to play is located regularly at both the former and latter part of the disk. However, when the positions of reproduction where the user wishes to play is located at a certain area such as gathered at the latter part of the disk, the extra operation of producing preview screens at a predetermined time interval would become useless.

### SUMMARY OF THE INVENTION

In view of the foregoing, an object of the present invention is to provide a disk reproduction apparatus and disk reproduction method that facilitates reproduction from a desired position on a disk by a user in a disk reproduction apparatus.

According to an aspect of the present invention, a disk reproduction apparatus includes a disk reproduction unit reproducing data recorded on a disk; a first input unit accepting a predetermined input; a marker display unit causing a display device to display a plurality of markers when there is an input at the first input unit during reproduction of data by the data reproduction unit; a second input unit accepting input of information selecting one marker from the plurality of markers displayed on the display device; an information storage unit storing, in association, information of displaying a selected marker and information of the position of reproduction on a disk in the data reproduction unit at a time point of input at the first input unit, in response to an input at the second input unit when data is being reproduced by the data reproduction unit; a thumbnail generation unit generating a thumbnail image of a still picture at the position of reproduction on the disk associated with the information of displaying a marker in the information storage unit, in response to an input at the first input unit when data is not being reproduced by the data reproduction unit; and a thumbnail display unit causing the display device to display the thumbnail image generated by the thumbnail generation unit.

Preferably in the disk reproduction apparatus of the present invention, the data reproduction unit causes the display device to display the picture of the data to be reproduced, and the marker display unit displays a marker at an area of the display region of the display device.

Further preferably, the disk reproduction apparatus of the present invention further includes a reproduction control unit causing the data reproduction unit to execute a reproduction operation from a position of reproduction on the disk associated with the information of displaying a selected marker in the information storage unit in response to an input at the second input unit when a thumbnail image is displayed on the display device.

According to another aspect of the present invention, a disk reproduction method includes the steps of: reproducing data recorded on a disk; accepting input of first information; causing a display device to display a plurality of markers in response to input of first information when data recorded on a disk is being reproduced; accepting input of second information selecting one marker from the plurality of markers displayed on the display device; storing, in association, information of displaying a selected marker and information of a position of reproduction on a disk at a time point of input of the first information, in response to input of second information when data recorded on a disk is being reproduced; generating, at the display device, a thumbnail image of a still picture at a position of reproduction on a disk associated with the information of displaying a marker in response to input of the first information when data recorded on a disk is not being reproduced; and causing the display device to display the generated thumbnail image.

Preferably in the disk reproduction method of the present invention, the picture of data recorded on the disk is displayed on the display device, and the plurality of markers are displayed at an area of the display region on the display device when data recorded on the disk is reproduced.

Further preferably, the disk reproduction method of the present invention further includes the step of executing a reproduction operation from a position of reproduction on a disk associated with the information of displaying a selected marker in response to input of the second information when the thumbnail image is displayed at the display device.

When the user operates the first input unit (or enters the first information) with respect to the disk reproduction apparatus in accordance with the present invention, a plurality of markers are displayed on the display device. The user selects one of the markers, and upon operating the-second input unit (or entering the second information), the position of reproduction on the disk at that time point is associated with the selected marker. A still picture at the position of reproduction associated with the marker is displayed on the display device as a thumbnail image. Accordingly, the user can register a desired position of reproduction at a desired timing. The user can easily confirm what picture the position of reproduction corresponds to by viewing the thumbnail image.

Since a marker is displayed at an area of a display device identical to the display device on which the image stored in the disk is reproduced in accordance with the present invention, the user does not have to take the trouble of viewing another display device for the purpose of registering a position of reproduction.

In accordance with the present invention, the user can initiate reproduction of data on a disk from a position of reproduction associated with a marker by the simple operation of selecting the relevant marker after the marker is set.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a structure of a DVD player identified as an example of a disk reproduction apparatus of the present invention.

FIG. 2 is a flow chart of the operation of setting a marker at the DVD player of FIG. 1.

FIG. 3 shows an example of a marker display region being displayed at a region of a screen of a TV monitor connected to the DVD player of FIG. 1.

FIG. 4 is an enlarged view of the marker display region of FIG. 3.

FIG. 5 schematically shows the stored contents in a specific region in a work memory of the DVD player of FIG. 1.

FIG. 6 is a flow chart of the operation of reproducing from a disk based on selection of a marker in the DVD player of FIG. 1.

FIG. 7 is a flow chart of an operation in a slide show executed in a modification of the DVD player of FIG. 1.

FIG. 8 shows an example of a marker display region displayed when the slide show of FIG. 7 is conducted.

### DESCRIPTION OF THE PREFERRED EMBODIMENTS

A disk reproduction apparatus including a marker setting system in accordance with an embodiment of the present invention will be described hereinafter.

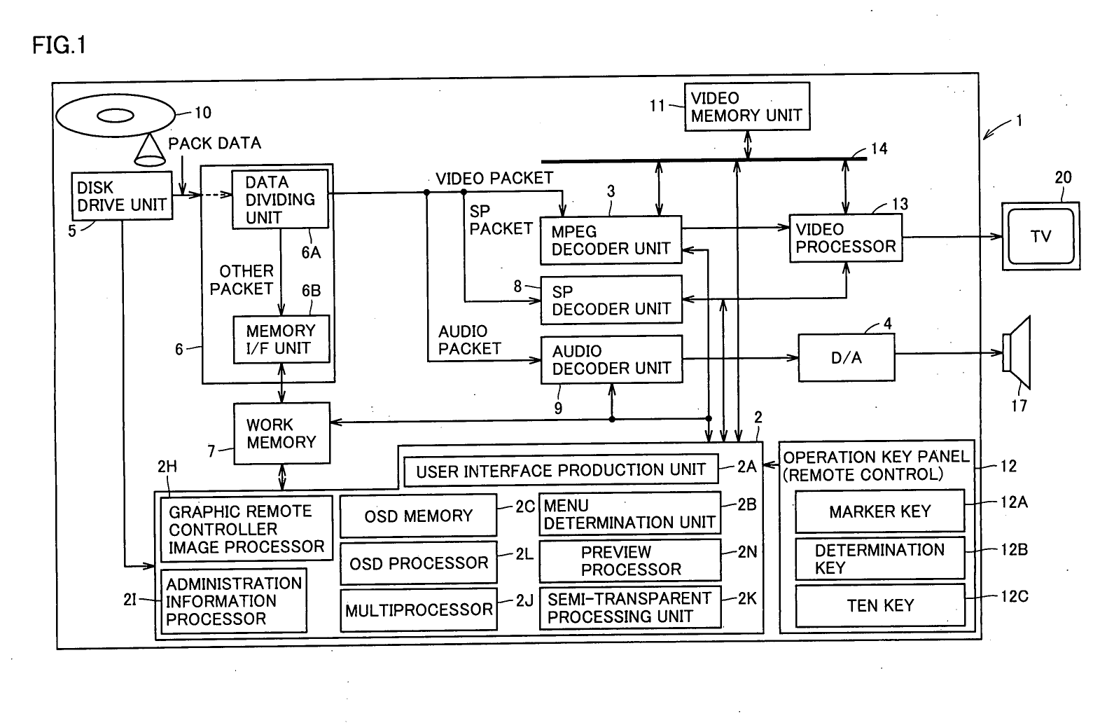

Referring to FIG. 1, a DVD player 1 includes, mainly, a MPU (Micro Processing Unit) 2, a MPEG (Moving Picture Experts Group) decoder unit (video decoder unit) 3, a D/A (Digital/Analog) converter 4 of audio data, a disk drive unit 5 reading out information from a DVD disk 10, a system processor 6, a work memory 7, a sub picture decoder (SP (Sub Picture) decoder) unit 8, an audio decoder unit 9, a video memory 11, an operation key panel (and/or remote controller) 12 identified as the input device for user operation, a video processor 13, and an internal bus 14. An external speaker 17 is connected via an audio amplifier (or AV amplifier) outside DVD player 1. Further, a TV (Television) monitor (or a video projector not shown) 20 is connected via a video I/F (Interface) not shown.

A user interface production unit 2A, a menu determination unit 2B, an OSD (On Screen display) processor 2L, a preview processor 2N, and the like are incorporated as firmware in MPU 2. Further, a data memory (data memory for OSD and other use) is provided in MPU 2. MPU 2 also has a graphic remote control image storage unit 2H, an administration information processor 2I, a multiple processor 2J, a multiprocessor 2J, a semi-transparent processor (or transparency processor) 2k, and the like incorporated as firmware.

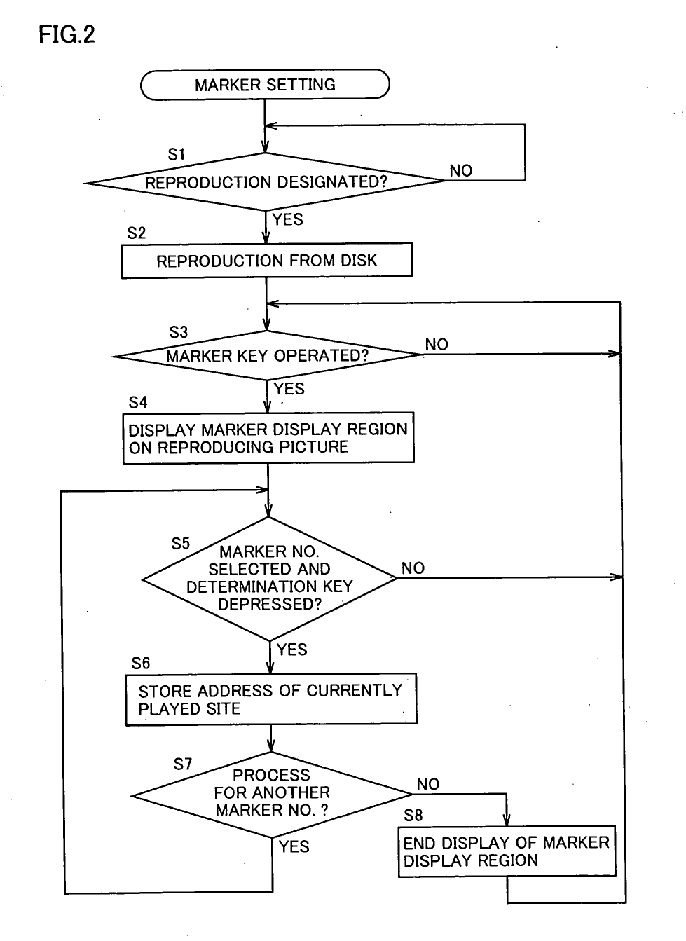

Although not shown, a program memory in which other firmware is written (program corresponding to the processing of FIGS. 2, 6 and 7) is provided in MPU 2. System processor 6 includes a data dividing unit 6A and a memory I/F unit 6B.

The basic flow of data in accordance with the configuration of FIG. 1 is set forth below. MPU 2 sends an address of interest and a read instruction to disk drive unit 5. Disk drive unit 5 reads out the logic sector data of interest from DVD disk 10 in accordance with the received address and instruction. The pack data read out is transmitted to system processor 6 via data input unit not shown. In system processor 6, data dividing unit 6A divides the received pack data into packet data, and transfers, in accordance with the contents (object) of the data, the video packet data (MPEG-encoded data) to video decoder unit 3, audio packet data to audio decoder unit 9, and subpicture packet data to SP decoder unit 8.

Video processor 13 converts the video information transmitted from video decoder unit 3 and/or SP decoder unit 8 into video data that can be displayed on TV monitor 20, and transfers the converted video data to TV monitor 20. D/A converter 4 converts the audio data transmitted from audio decoder unit 9 into analog data, and transfers the analog data to a speaker 17. Thus, the picture recorded on disk 10 is displayed on TV monitor 20 whereas the audio recorded on disk 10 is output from speaker 17.

The header of a navigation pack NV_PCK and other packs (audio pack A_PCK, video pack V_PCK, subpicture pack SP_PCK, and the like) is transferred to and stored in work memory 7 via memory I/F unit 6B by being processed appropriately by MPU 2. Each packet data sent to respective decoder units are subjected to reproduction processing in synchronization with the value of a reproduction time stamp (Presentation Time Stamp: PTS) in the packet data. Accordingly, a motion picture (movie) with English audio output and Japanese caption can be displayed on TV monitor 20.

In MPU 2, an on-screen display (OSD) is generated to provide user interface to allow a user to confirm through visual operation, based on the internal data in data memory 2C. This OSD generation is executed by the firmware of a user interface production unit 2A. The generated OSD data is stored in video memory 11. MPU 2 includes, in the form of firmware, a menu determination unit 2B that determines the type of menu output from the disk 10 (whether a route menu, title menu, or the like).

Operation key panel 12 includes the general keys to operate a DVD player (a key to designate reproduction, a key to designate the stop of a reproduction operation, and the like), as well as a marker key 12A used for setting a marker as will be described afterwards, a determination key 12B, and a ten key 12C to input the ten figures of 1 to 0.

In response to a predetermined operation during reproduction of information from a disk at DVD player 1, a marker is displayed on the screen, and the displayed marker can be associated with the position of reproduction at that time point. The association of a marker with a position of reproduction is referred to as “setting a marker”. By selecting a relevant marker after markers are set in DVD player 1, a disk can be played back starting from a position of reproduction corresponding to the relevant marker. Setting a marker by the predetermined operation set forth above, and the operation of DVD player 1 in a disk reproducing operation based on marker selection will be described hereinafter.

FIG. 2 is a flow chart of an operation of DVD player 1 in a marker setting process.

Referring to FIG. 2, when MPU 2 determines that information of designating reproduction from a disk is input through operation key panel 12 (determination of YES at step S1: step abbreviated as S hereinafter), control proceeds to S2 where a disk is played. In the reproducing operation from a disk, the reproduced picture is displayed on TV monitor 20 whereas audio is output through speaker 17.

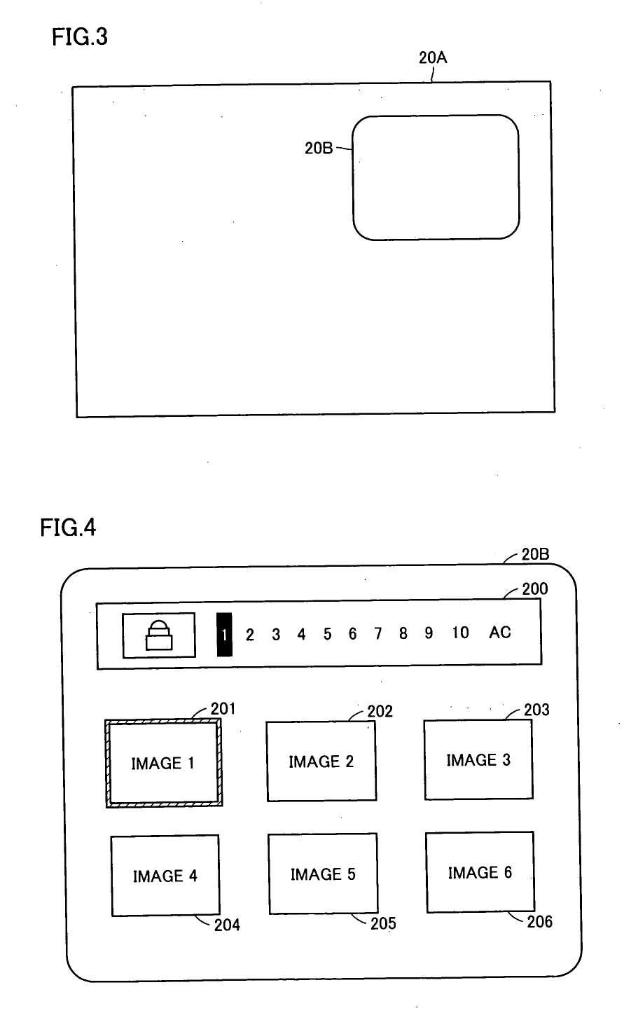

When MPU 2 determines that marker key 12A has been operated (YES at S3), control proceeds to S4 where a marker display region including a marker is displayed at a region on the screen of TV monitor 20 on which the reproducing picture is displayed. FIG. 3 schematically shows an example of a marker display region displayed at a region on the screen of TV monitor 20.

In response to an operation of marker key 12A, a marker display region 20B including a marker is displayed at a region in screen 20A of TV monitor 20, as shown in FIG. 3. The reproducing picture of the data stored on disk 10 is displayed on screen 20A of TV monitor 20. Marker display region 20B is displayed in an overlapping manner on a region of the reproducing picture.

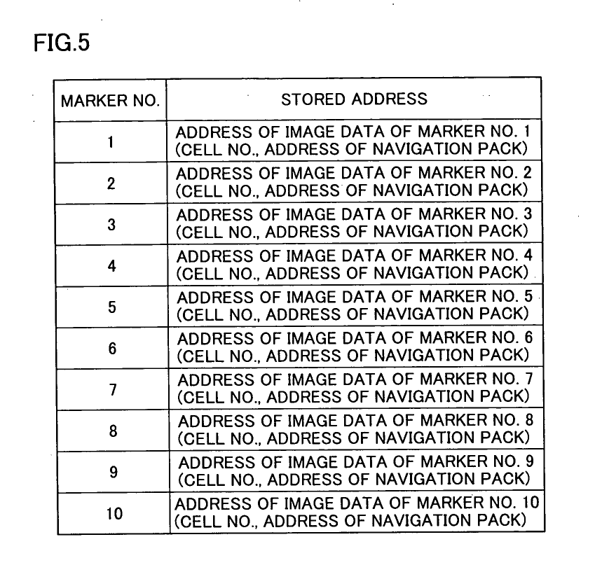

Referring to FIG. 4, a marker number display region 200 indicating marker numbers from 1 to 10 (marker number indicated as “marker No.” hereinafter), and thumbnail display regions 201-206 corresponding to respective marker numbers (in the example of FIG. 4, corresponding to marker Nos. 1-6) 201-206 are displayed in marker display region 20B. For example, thumbnail display region 201 corresponds to marker No. 1, and thumbnail display region 206 corresponds to marker No. 6. In thumbnail display regions 201-206 are shown the thumbnail images of a still picture of a relevant address to which a corresponding marker No. is associated with. Before such association is assigned, each of thumbnail display regions 201-206 provide display indicating that the relevant display corresponds to a marker No., and that association with an address for that marker No. is not yet set.

Referring to FIG. 2 again, when a reproducing picture and marker display region 20B are displayed in a multiplexed manner on TV monitor 20, determination is made by MPU 2 at S4 whether the series of operation of selecting a marker No. and depressing determination key 12B through operation key panel 12 have been made or not. When determination is made that such series of operation have been conducted, control proceeds to S6. A marker No. can be selected by, for example, depressing an appropriate ten-key 12C, or through operation of a cursor.

In response to selection of a marker No., the corresponding marker No. in display region 200 is displayed in a highlighted manner. FIG. 4 corresponds to the case where “1” is selected as the marker No. Furthermore, the outer frame of a corresponding display region in response to selection of a marker No. is displayed in a highlighted manner (the outer frame of thumbnail display region 201 is highlighted when “1” is selected as the marker No.).

At S6, MPU 7 stores the address on disk 10 currently played into a specified region of work memory 7 in association with the marker No. selected at S5. Then, control proceeds to step S7. The stored contents of the specified region of work memory 7 is schematically shown in FIG. 5.

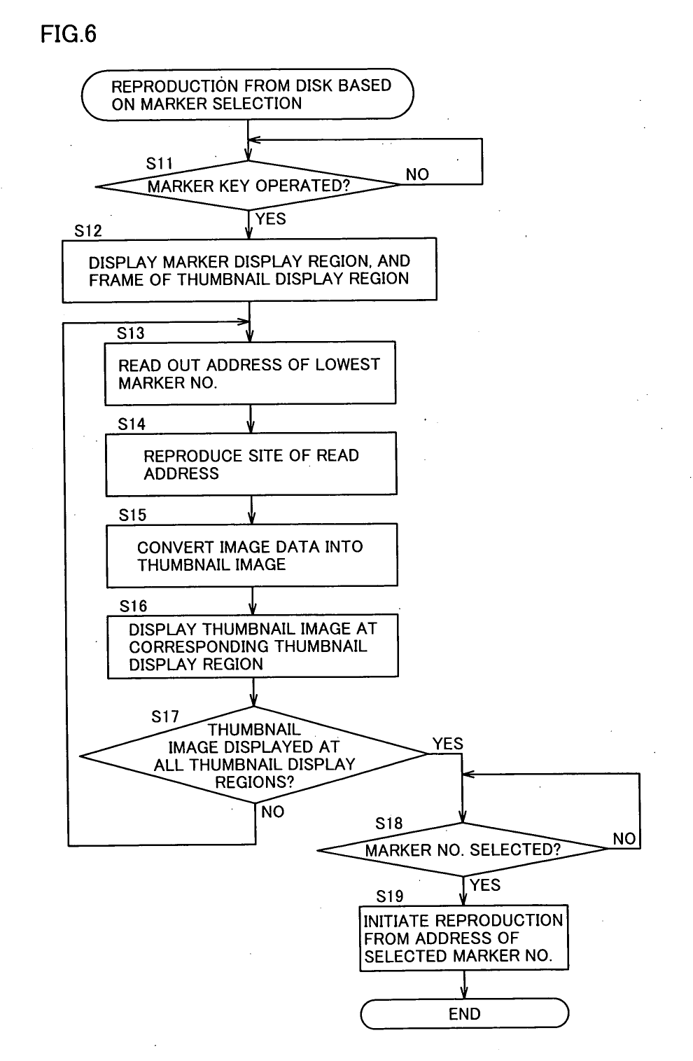

Referring to FIG. 5, the address on disk 10 is stored in association with each marker No. in the specified region of work memory 7. As indicated by “address of image data of marker No. 1(-10)” in FIG. 5, each marker No. is associated with an address of image data since a thumbnail image of a still picture at the address on disk 10 corresponding to a marker No. is displayed in marker display region 20B in the present embodiment, as shown in FIG. 6. In the present specification, this data of a thumbnail image is identified as the image data of marker Nos. 1-10, and taken equivalent to the address on disk 10 currently displayed when a marker No. is associated with an address at S6 in the specified region in work memory 7.

At S7, MPU 2 determines whether an operation to further execute the process of associating a marker No. with an address on disk 10, as indicated at S5-S6, has been carried out through operation key panel 12. When determination is that such an operation has been made, control returns to S5, otherwise, to S8.

At S8, MPU 2 terminates the display of marker display region 20B in screen 20A, and control returns to S3.

The operation of DVD player 1 in a disk reproduction operation based on marker selection will be described hereinafter.

Referring to FIG. 6, MPU 2 determines whether marker key 12A has been operated or not under the status where disk 10 is not played in DVD player 1 at S11. When determination is made that marker key 12A has been operated, control proceeds to S12.

At S12, MPU 2 displays marker display region 20B on TV monitor 20. Furthermore, the frames of thumbnail display regions 201-206 (refer to FIG. 4) are also displayed in marker display region 20B.

At S13, MPU 2 refers to the stored content shown in FIG. 5 in the specified region in work memory 7 for the lowest marker No. among the numbers that are not yet the object of the process of steps of S14 et al. in display region 200 to read out an address corresponding to the relevant marker No.

At S14, MPU 2 plays disk 10 from a position corresponding to the relevant address on disk 10.

At S15, MPU 2 extracts image data of the still picture of the site corresponding to the relevant address, and converts the image data into a shrunk image (thumbnail image).

At S16, MPU 2 displays the thumbnail image generated by the conversion at S15 in the frame of the corresponding thumbnail display.

At S17, MPU 7 determines whether a thumbnail image has been displayed in all the thumbnail display regions whose frame is displayed in marker display region 20B and whose address is associated with a corresponding marker No. If determination is made that all the thumbnail images has been displayed, control proceeds to S 18, otherwise to S13.

At S18, MPU 2 determines whether an operation of selecting a marker No. in marker No. display region 200 has been made through operation key panel 12. When determination is made that such an operation has been conducted, control proceeds to S19 to carry out a process of initiating reproduction from disk 10 starting from the address corresponding to the specified marker No. Then, the process is terminated.

By operating marker key 12A during a playing operation of disk 10 in DVD player 1 of the present embodiment in accordance with the processes described with reference to FIGS. 5 and 6, the current address on disk 10 played back at that time point is registered as a book mark. By operating marker 12A when disk 10 is not played, the still picture of the address registered as a book mark is displayed as a thumbnail image in thumbnail display regions 201-206 in marker display region 20B. In response to selection of a marker No. corresponding to the relevant thumbnail image in display unit 200 by the user, DVD player 1 can initiate playing of disk 10 starting from the address corresponding to the selected marker No.

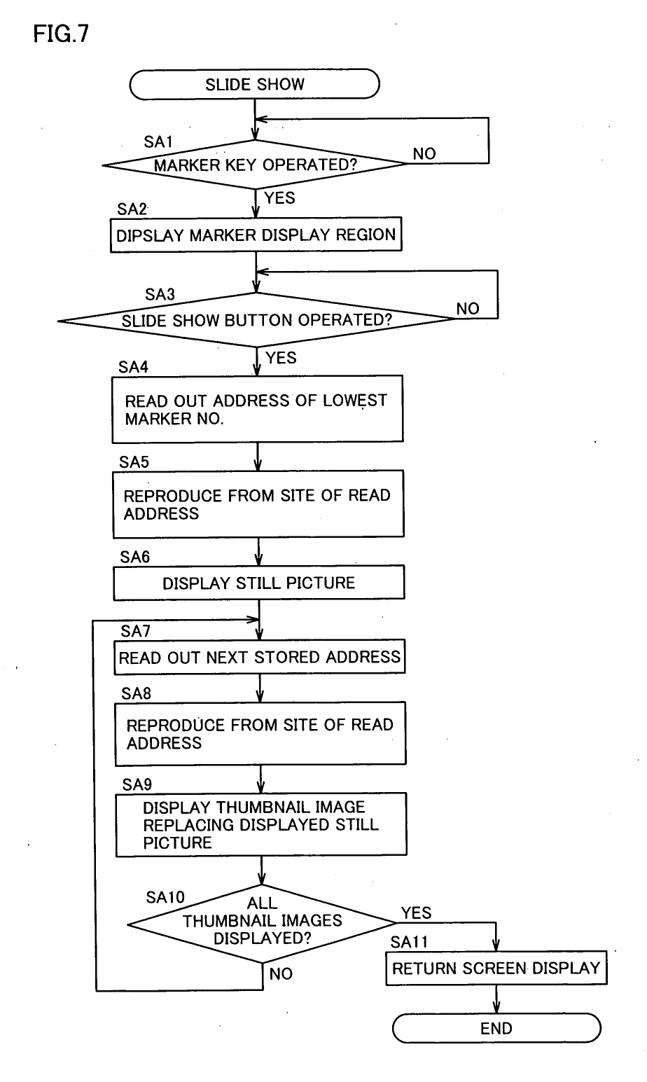

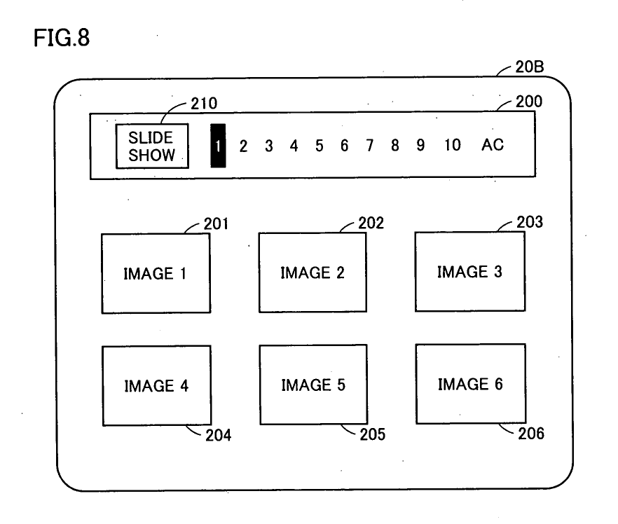

With regards to the address registered as a book mark in accordance with the procedure shown in FIG. 2 in DVD player 1, the still picture of a corresponding address may be displayed sequentially as a slide show. Such a modification will be described hereinafter with reference to the flow chart of FIG. 7.

In the present modification, MPU 2 determines whether marker key 12A has been operated or not under the status where disk 10 is not currently played at DVD player 1 in SA1. When determination is made that marker key 12A has been operated, control proceeds to SA2.

At SA2, MPU 2 displays marker display region 20B as shown in FIG. 3 on the screen of TV monitor 20 (screen 20A). In marker display region 20B of the present modification, a slide show button 210 is additionally displayed in display 200.

At SA3, MPU 2 determines whether an operation to select slide show button 210 on operation key panel 12 has been made or not. When determination is made that such an operation has been conducted, control proceeds to SA4.

At SA4, MPU 2 refers to the stored contents shown in FIG. 5 in the specified region of work memory 7 for the lowest marker No. to read out the address corresponding to the relevant marker No.

At SA5, MPU 2 initiates reproduction from a site corresponding to the relevant address on disk 10.

At SA6, MPU 2 derives image data of the still picture of the site corresponding to the relevant address, and converts the derived image data into a shrunk image (thumbnail image). This shrunk image is displayed on screen 20A.

At SA7, MPU 2 reads out the address corresponding to a marker No. next to the marker No. to which the currently displayed thumbnail image on screen 20A corresponds, from the stored contents of FIG. 5.

At SA8, MPU 2 initiates reproduction from a site corresponding to the address read out at SA7.

At SA9, MPU 2 derives image data of the still picture of the site reproduced at the previous SA8, and converts the derived image data into a shrunk image (thumbnail image). This thumbnail image is displayed on screen 20A, replacing the currently displayed thumbnail image.

At SA10, MPU 2 determines whether a thumbnail image has been displayed for all marker Nos. to which an address has been associated with in FIG. 5. When determination is made that the thumbnail images have been displayed, control proceeds to SA11, otherwise to SA7.

At SA1, a process of restoring the display of screen 20B to a status prior to the slide show as shown in FIG. 3 is conducted. Then, the slide show is terminated.

In the slide show set forth above, each thumbnail image is displayed occupying the entire screen 20A. However, the display manner of a thumbnail image in a slide show is not limited thereto, and may be modified appropriately.

In the present embodiment, DVD player is connected to an external TV monitor 20 and speaker 17 from which the picture and audio reproduced from disk. 10 are output. The disk reproduction apparatus of the present invention is not limited thereto, and may include a TV monitor and a speaker.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A disk reproduction apparatus comprising:
a data reproduction unit reproducing data recorded on a disk,
a first input unit accepting a predetermined input,
a marker display unit causing a display device to display a plurality of markers when there is an input at said first input unit during reproduction of data by said data reproduction unit,
a second input unit accepting input of information selecting one marker from said plurality of markers displayed at said display device,
an information storage unit storing, in association, information of displaying said selected marker and information of a position of reproduction on a disk in said disk reproduction unit at a time point of input to said first input unit, in response to input to said second input unit when data is being reproduced by said data reproduction unit,
a thumbnail generation unit generating a thumbnail image of a still picture at a position of reproduction on said disk associated with said information of displaying a marker in said information storage unit, in response to an input at said first input unit when data is not being reproduced by said data reproduction unit, and
a thumbnail display unit causing said display device to display the thumbnail image generated by said thumbnail generation unit.

2. The disk reproduction apparatus according to claim 1, wherein
said data reproduction unit causes said display device to display a picture of the data to be reproduced, and
said marker display unit displays said marker at an area on a display region of said display device.

3. The disk reproduction apparatus according to claim 1, further comprising a reproduction control unit causing said data reproduction unit to execute a reproduction operation from a position of reproduction on said disk associated with information of displaying said selected marker in said information storage unit in response to input to said second input unit when said thumbnail image is displayed at said display device.

4. A disk reproduction method comprising the steps of:
reproducing data stored on a disk,
accepting input of first information,
causing said display device to display a plurality of markers in response to input of first information when data recorded on a disk is being reproduced,
accepting input of second information selecting one marker from said plurality of markers displayed at said display device,
storing, in association, information of displaying said selected marker and information of a position of reproduction on said disk at a time point of input of said first information, in response to input of said second information when data recorded on a disk is being reproduced,
generating, at said display device, a thumbnail image of a still picture of a position of reproduction on said disk associated with information of displaying a marker in response to input of said first information when data recorded on said disk is not being reproduced, and
causing said display device to display said generated thumbnail image.

5. The disk reproduction method according to claim 4, wherein a picture of data recorded on said disk is displayed at said display device when data recorded on said disk is reproduced,
said plurality of markers being been displayed at an area of a display region of said display device.

6. The disk reproduction method according to claim 4, further comprising the step of executing a reproduction operation starting from a position of reproduction on said disk associated with information of displaying said selected marker in response to input of said second information when said thumbnail image is displayed at said display device.
